(19) United States
(12) Patent Application Publication
(10) Pub. No.: US 2026/0224340 A1
(43) Pub. Date: Aug. 6, 2026

(54) Novelty Dental Floss Dispenser

(71) Applicant: Green Straw LLC, Clearwater, FL (US)

(72) Inventors: Jay Kamhi, Belleair, FL (US); Simeon E. Tiefel, Siloam Springs, AR (US)

(21) Appl. No.: 19/045,370

(22) Filed: Feb. 4, 2025

(51) Int. Cl. A61C 15/04

(52) U.S. Cl. CPC A61C 15/043

(57) ABSTRACT

A novelty dental floss dispenser in the form of a character having a base, a head, and a head covering. The head defines an internal area that is accessible through a top opening. The head covering is used to selectively cover the top opening in the head. A spool of dental floss is provided. The spool is disposed within the internal area of the head and a free end of the dental floss exits the head through a side hole in the head. A cutting blade is affixed to the base of the character, wherein the cutting blade cuts the dental floss when the dental floss is biased against the cutting blade.

### BACKGROUND OF THE INVENTION

### 1. Field of the Invention

In general, the present invention relates to assemblies that hold and dispense dental floss.

### 2. Prior Art Description

The use of dental floss is an important part of a proper dental hygiene regimen. The use of dental floss removes material from between the teeth and along the gums that can a cause tooth decay and gum inflammation. Flossing also removes bacteria and plaque buildup between the teeth and along the gums.

Dental floss was invented in the mid 1800's. The original dental floss was silk thread coated in wax. The dental floss was initially sold on the same spool that held the silk thread. To use the dental floss, lengths of floss were cut from the spool using a knife or scissors. To avoid the need to cut the dental floss, short lengths of dental floss were sold wrapped around toothpicks. Such an assembly is shown in U.S. Pat. No. 407,362 to Mason.

In modern times, dental floss is wound on a spool and the spool is held in a molded housing. The housing keeps the dental floss clean, dry, and sanitary. A cutting head is also molded into the housing. To use the dental floss, a length of dental floss is drawn from the threaded spool through an opening in the housing. The drawn length of dental floss is then pulled across a cutting head to remove a length of dental floss from the assembly. Such dental floss dispensers are exemplified by U.S. Pat. No. D720,096 to McDougall and Korean Patent 101416602B1 to Kim Gil-Joong.

Many people consider using dental floss to be a tedious chore. As such, the step of flossing is often skipped and the dental floss is left out of sight in a drawer. When the dental floss is out of sight, it is often out of mind, therein causing more instances of non-use.

A need therefore exists for a dental floss dispenser that has a novel appearance and functionality, wherein the dental floss dispenser is more likely to be left on a countertop. The novelty dental floss dispenser will bring the dental floss to mind each time a person sees the dispenser. This will lead to increased use of dental floss and improved dental hygiene. This need is met by the present invention as described and claimed below.

### SUMMARY OF THE INVENTION

The present invention is a novelty dental floss dispenser in the form of a character. The character has a base, a head, and a head covering. The head is hollow and defines an internal area that is accessible through the top opening in the head. The head covering is attachable and detachable and is used to selectively cover the top opening in the head.

A spool of dental floss is provided. The spool is disposed within the internal area of the head. The spool is accessible through the top opening in the head upon detachment of the head covering from the head. This enables the spool of dental floss to be replaced when empty. When the spool of dental floss is in the head, the free end of the dental floss exits the head through a side hole in the head.

A cutting blade is affixed to the base of the character, wherein the cutting blade cuts the dental floss when the dental floss is biased against the cutting blade.

### BRIEF DESCRIPTION OF THE DRAWINGS

For a better understanding of the present invention, reference is made to the following description of exemplary embodiments thereof, considered in conjunction with the accompanying drawings, in which:

FIG. 1 shows an exemplary embodiment of the present invention dental floss dispenser;

FIG. 2 shows the exemplary embodiment of FIG. 1 with a length of dental floss being drawn from the dispenser and being manipulated against a cutting blade;

FIG. 3 shows an exploded view of the exemplary embodiment of FIG. 1;

FIG. 4 shows a front-to-back cross-sectional view of the exemplary embodiment of FIG. 1;

FIG. 5 shows a left-to-right cross-sectional view of the exemplary embodiment of FIG. 1; and

FIG. 6 shows an alternate exemplary embodiment of the present invention dental floss dispenser.

### DETAILED DESCRIPTION OF THE DRAWINGS

Although the present invention dental floss dispenser can be embodied in many ways, only two exemplary embodiments are shown. These embodiments are selected in order to set forth two of the best modes contemplated for the invention. The illustrated embodiments, however, are merely exemplary and should not be considered limitations when interpreting the scope of the appended claims.

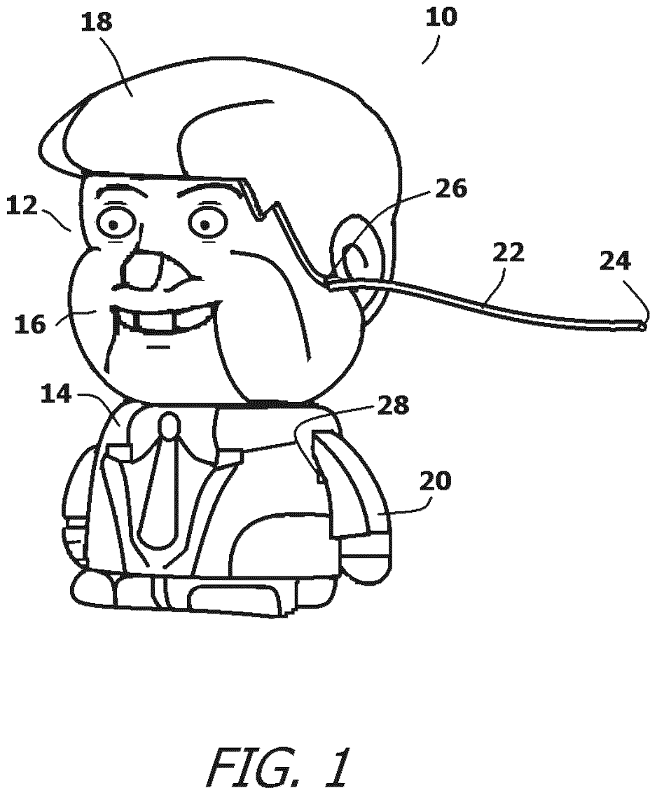

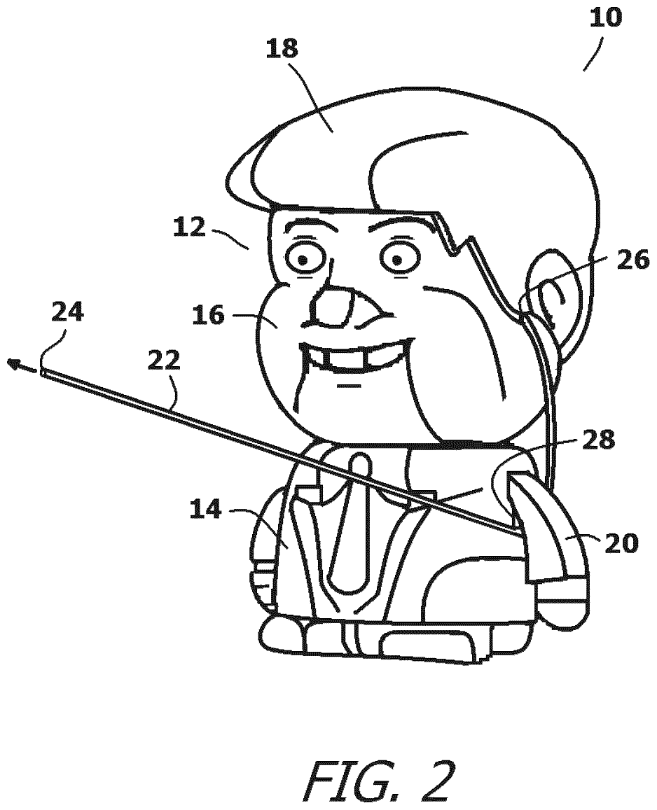

Referring to FIG. 1 in conjunction FIG. 2, a novelty dental floss dispenser 10 is shown that is shaped as a character 12. The character 12 has a base 14, a head 16, a head covering 18, and appendages 20. In the shown embodiment, the character 12 is a caricature of President Donald Trump. However, such a character 12 is merely exemplary and it should be understood that the character 12 can be any person or any anthropomorphized animal or object. It is preferred that the character 12 be a person or thing that is known to have wild hair, such as Donald Trump or Albert Einstein. Anthropomorphized characters with predominant heads of hair, such as a lion, can also be used. Although a character with wild hair is preferred, other licensed characters, such as a Pakeman® character or a Disney character® can also be adapted to the present invention.

The head 16 of the character 12 is capped with the head covering 18. The head covering 18 can be the hair of the character 12, a hat, or another such construct. The character 12 is the housing for a supply of dental floss 22, wherein the dental floss 22 is dispensed from within the character 12. The dental floss 22 is stored on a spool that is housed within the character 12. The dental floss 22 has a free end 24. The free end 24 of the dental floss 22 exits the character 12 from the head 16 of the character 12, through a slotted hole 26. The slotted hole 26 is partially covered by the head covering 18. As a result, the dental floss 22 exits the character's head 12 at or near the hair line or hat line of the character 12. In this manner, the strand of dental floss 22 extending from the head 16 has the appearance of being a stand of hair extending from the hair of the character 12 or a thread extending from a hat. For this reason, it is preferred that the dental floss 22 be colored to match the color scheme of the character's hair or hat. For example, if the character 12 is configured to look like Donald Trump with yellow hair, the dental floss 22 in use is preferably yellow. Alternatively, if the character is configured to look like Albert Einstein with white hair, the dental floss 22 in use is preferably white.

The dental floss 22 extends from the head 16 of the character 12. To use the dental floss 22, a user grasps the dental floss 22 near the free end 24 and pulls a length of the dental floss 22 out of the character 12. Once the desired length of floss 22 is drawn, the dental floss 22 is manipulated under one appendage 20 of the character 12. As will be explained in more detail, a cutting blade 28 is positioned under one arm. As the dental floss 22 is directed under the appendage 20 and pulled, the dental floss 22 is cut. The uncut portion of the dental floss 22 is then free to return to its position extending from the head 16 of the character 12.

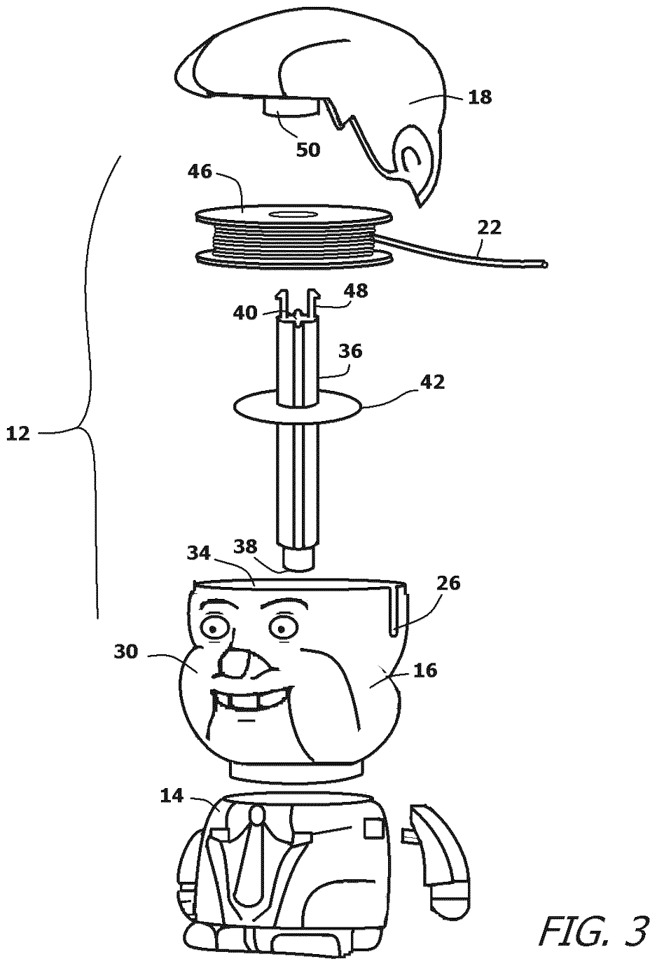

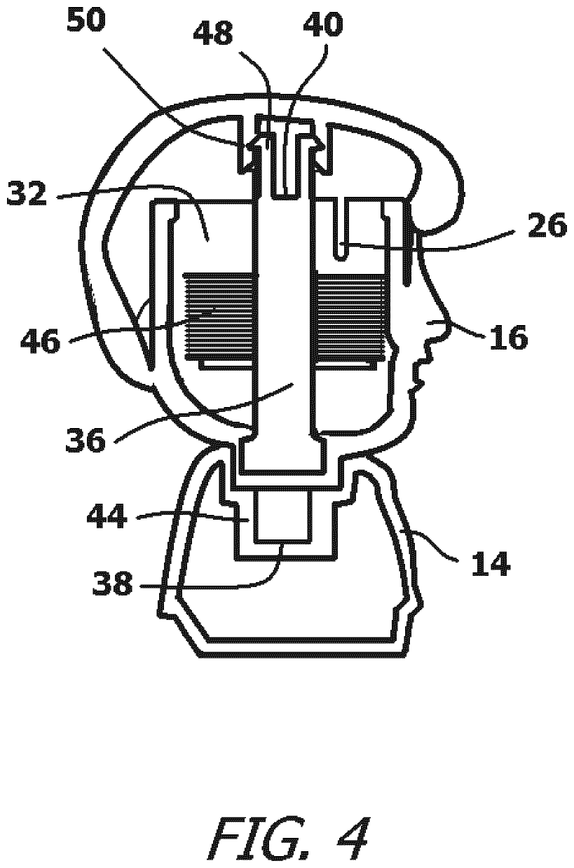

Referring to FIG. 3 and FIG. 4 in conjunction with FIG. 1 and FIG. 2, it can be seen that the character 12 has a base 14. Depending upon the theme of the character 12, the base 14 can be shaped as the torso and legs of the character 12. The base 14 of the character 12 enables the character 12 to stand freely on a flat surface.

The head 16 of the character 12 connects to the base 14. The head 16 of the character 12 contains a molded face 30. The slotted hole 26 is formed in the head 16. The head 16 of the character 12 is hollow and defines an internal area 32. Furthermore, the top of the head 16 defines an opening 34 to provide access to the internal area 32.

A post 36 is provided. The post 36 has a first end 38 and an opposite second end 40. Furthermore, a flange 42 radially extends from the post 36 at an elevation between the first end 38 and the second end 40. The first end 38 of the post 36 passes through the head 16 of the character 12 and is received within a receptacle 44 in the base 14 of the character 12. As such, the post 36 extends up through the internal area 32 of the head 16. A spool 46 of dental floss 22 is provided that is sized to fit within the internal area 32 of the head 16. The spool 46 passes over the second end 40 of the post 36, wherein the post 36 acts as a spindle for the spool 46. The spool 46 rests upon the flange 42 on the post 36 within the head 16. This positions the spool 46 at the proper elevation within the head 16 of the character 12. The dental floss 22 can therefore be easily manipulated from the spool 46 through the slotted hole 26 in the side of the head 16. The spool 46 can be selectively replaced on the post 36. As such, a new spool of dental floss can be placed into the head 16 of the character 12 when an old spool is emptied.

The second end 40 of the spool 46 is terminated with a connector 48. The connector 48 serves two purposes. First, the connector 48 keeps the spool 46 on the connector 48, and prevents the spool 46 from inadvertently separating from the post 36. Once the spool 46 of dental floss 22 is empty, the connector 48 can be manually compressed to enable the spool 46 to be removed. The second purpose of the connector 48 is to engage a receptacle 50 on the head covering 18 and connect the head covering 18 to the character 12.

The head covering 18 is externally shaped like a head of hair, a hat, antlers or other head adornment. The head covering 18 is sized to pass over the head 16 of the character 12 and cover the opening 34 at the top of the head 16. Internally, the head covering 18 has a receptacle 50 that receives and engages the connector 48 on the second end 40 of the post 36. When the head covering 18 is engaged with the post 36, the head covering 18 covers most of, but not all, of the slotted hole 26 in the head 16. Enough of the slotted hole 26 remains open to accommodate the passage of a strand of the dental floss 22.

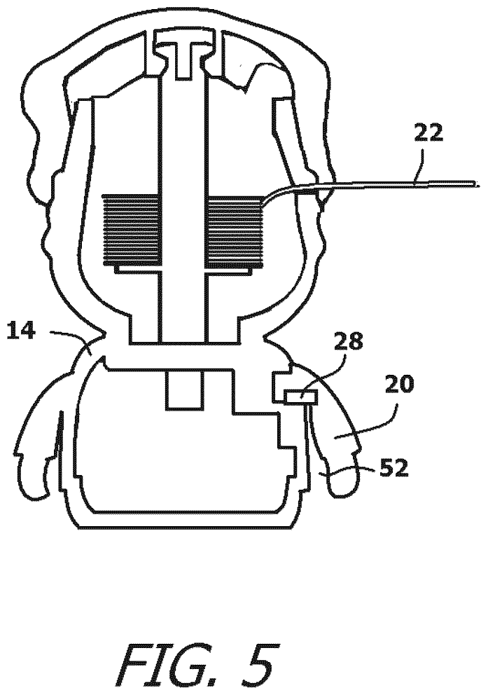

Referring to FIG. 5 in conjunction with FIG. 2, it can be seen that the character 12 has at least one appendage 20 that extends from the base 14 of the character 12. The appendage 20 can be an arm, leg, tail, piece of clothing or another such object that complements the overall theme of the character 12. The appendage 20 extends slightly away from the base 14 of the character 12 so that a small gap space 52 exists between the base 14 and the appendage 20. The gap space 52 narrows from bottom toward the top. At its narrowest point at the top, the gap space 52 is only slightly wider than the dental floss 22. At the top of the gap space 52, the cutting blade 28 is provided. The cutting blade 28 is only exposed within the gap space 52 between the base 14 and the appendage 20. Accordingly, nothing wider than the dental floss 22 can be brought into contact with the cutting blade 28.

Referring to all figures, it will be understood that to use the dental floss dispenser 10, the spool 46 of dental floss 22 must be loaded into the character 12. To load the character 12, the head covering 18 is removed. This exposes the opening 34 at the top of the head 16. The spool 46 of dental floss 22 is provided and is placed onto the post 36 inside the internal area 32 of the head 16. The spool 46 of dental floss 22 rests on the flange 42 that radially extends from the post 36. This holds the spool 46 at the proper height for use. The free end 24 of the dental floss 22 is extended out of the head 16 and the dental floss 22 is extended through the slotted hole 26 in the head 16. The head covering 18 is then attached to the connector 48 on the post 36. This covers the opening 34 in the head 16 and locks the spool 46 of dental floss 22 inside the character 12.

The dental floss 22 extends out of the character 12 through the slotted hole 26. To obtain a length of the dental floss 22 for use, the dental floss 22 is manually grasped near its free end 24. A desired length of dental floss 22 is then pulled from the head 16 of the character 12. Once the desired length of the dental floss 22 is extended, the dental floss 22 is directed into the gap space 52 between the base 14 and the appendage 20. The dental floss 22 is then manually biased against the cutting blade 28 until the dental floss 22 is cut. Once the dental floss 22 is cut, the desired length is removed. The free end 24 of the dental floss 22 then extends from the head 16 where it can be easily grasped. The dental floss 22 extending from the head 16 appears to be a hair extending from the hair line between the head 16 and the head covering 18.

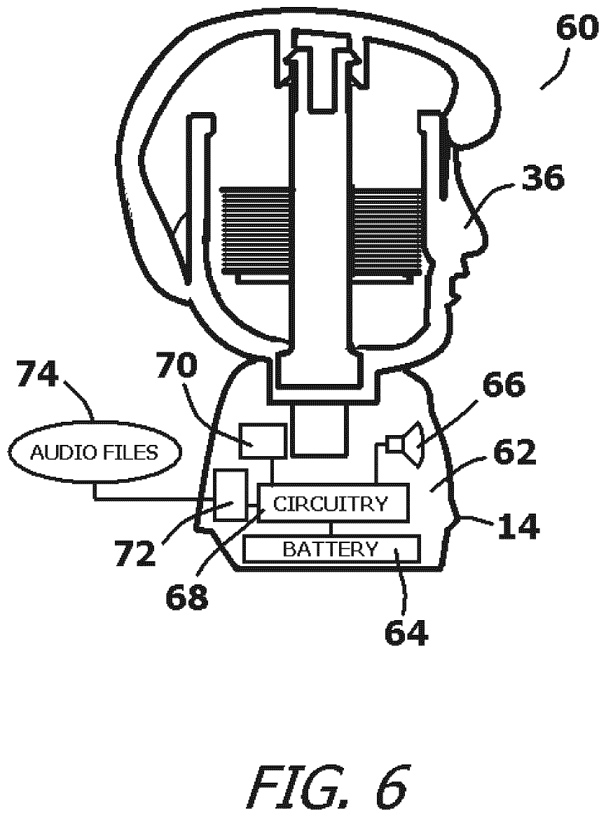

Referring to FIG. 6, an alternate embodiment of a dental floss extender 60 is shown. This embodiment has all the same components as the first embodiment and the same reference numbers will be used to reference the same parts. The difference in the second embodiment is the addition of an electronics module 62 in the base 14 of the character 12. The electronics module 60 contains a battery 64, a speaker 66, control circuitry 68, an activation switch 70 and a read-only memory 72. The memory 72 holds one or more audio files 74 that are played over the speaker 66 when the activation switch 70 is triggered. The activation switch 70 is triggered by any rotation of the post 36. The post 36 holds the spool 46 of dental floss 22. The post 36 is not round and smooth. Rather, the post 36 has an X-shaped cross-sectional profile. Accordingly, when a length of dental floss 22 is pulled from the spool 46, friction applies some torque to the post 36. This causes the post 36 to slightly rotate. This rotation is detected by the activation switch 70. When the activation switch 70 is triggered, one of the audio files 74 is played. Accordingly, every time a length of dental floss 22 is drawn from the character 12, the character 12 will audibly broadcast an audio file 74. The audio file 74 can be music, but is preferably a quote or sound from the person, animal or object the character 12 is intended to represent.

It will be understood that the embodiments of the present invention that are illustrated and described are merely exemplary and that a person skilled in the art can make many variations to those embodiments. All such embodiments are intended to be included within the scope of the present invention as defined by the claims.

What is claimed is:

1. A dental floss dispenser, comprising:
a character having a base, a head, and a head covering, wherein said head defines an internal area accessible through a top opening in said head, and wherein said head covering is detachable and selectively covers said top opening in said head;
a spool that holds dental floss, wherein said spool is disposed in said internal area of said head, wherein said spool is accessible through said top opening in said head upon detachment of said head covering from said head, and wherein said dental floss has a free end that extends out of said head through a hole in said head; and
a cutting blade affixed to said base of said character, wherein said cutting blade cuts said dental floss when said dental floss is biased against said cutting blade.

2. The dental floss dispenser according to claim 1, further including an appendage extending from said base, wherein a gap space exists between said base and part of said appendage, and wherein said cutting blade is only exposed within said gap space.

3. The dental floss dispenser according to claim 2, wherein said gap space diverges toward said cutting blade.

4. The dental floss dispenser according to claim 1, wherein said appendage is an arm.

5. The dental floss dispenser according to claim 1, further including a post that extends through said internal area of said head, wherein said spool rotates about said post.

6. The dental floss dispenser according to claim 5, wherein said post terminates with a connector that selectively connects said head covering to said post.

7. The dental floss dispenser according to claim 5, wherein a flange is formed on said post that supports said spool at an elevation within said internal area of said head.

8. The dental floss dispenser according to claim 1, wherein said hole in said head is a slotted hole that extends to said top opening of said head.

9. The dental floss dispenser according to claim 1, wherein said head contains a face formed thereon and said head covering is selected from a group consisting of hair, hats and horns.

10. The dental floss dispenser according to claim 1, wherein said head covering includes a depiction of hair of a particular color and said dental floss has a color that matches said particular color.

11. The dental floss dispenser according to claim 1, wherein said character is selected from a group consisting of a person, an anthropomorphized animal, and an anthropomorphized object.

12. The dental floss dispenser according to claim 1, wherein said base includes a torso and legs for said character.

13. A dental floss dispenser, comprising:
a character having a torso and a head, wherein said head defines an internal area accessible through both a top opening in said head and a side hole in said head;
a post within said internal area;
dental floss wound on a spool, wherein said spool rotates about said post within said internal area of said head, wherein said spool is accessible through said top opening in said head, and wherein said dental floss has a free end that extends out of said head through said side hole in said head; and
a head covering that is attachable to, and detachable from, said post, wherein said head covering selectively covers said top opening in said head when attached to said post.

14. The dental floss dispenser according to claim 13, further including a cutting blade affixed to said character, wherein said cutting blade cuts said dental floss when said dental floss is biased against said cutting blade.

15. The dental floss dispenser according to claim 14, further including an appendage extending from said torso, wherein a gap space exists between said torso and part of said appendage, and wherein said cutting blade is only exposed within said gap space.

16. The dental floss dispenser according to claim 15, wherein said gap space diverges toward said cutting blade.

17. The dental floss dispenser according to claim 13, wherein said post terminates with a connector that selectively connects said head covering to said post.

18. The dental floss dispenser according to claim 13, wherein a flange is formed on said post that supports said spool at an elevation within said internal area of said head.

19. The dental floss dispenser according to claim 13, further including electronics within said character that play an audio file each time a length of said dental floss is unwound from said spool.
